(19) United States
(12) Patent Application Publication
(10) Pub. No.: US 2024/0230068 A1
(43) Pub. Date: Jul. 11, 2024

(54) Lamp

(71) Applicants: ETI SOLID STATE LIGHTING INC, Wheeling, IL (US); CRAWFORD GLOBAL LIMITED, Hong Kong (CN)

(72) Inventors: Donglei WANG, Zhuhai (CN); Bingbing ZHOU, Zhuhai (CN); Songhong DING, Zhuhai (CN); Xiongwen YIN, Zhuhai (CN)

(21) Appl. No.: 18/406,239

(22) Filed: Jan. 8, 2024

(30) Foreign Application Priority Data
Jan. 9, 2023 (CN) 202320075684.6

(51) Int. Cl. F21V 21/04; F21V 7/04; F21V 11/08; F21V 17/00; F21V 23/04

(52) U.S. Cl. CPC F21V 21/047; F21V 7/04; F21V 11/08; F21V 17/002; F21V 23/04

(57) ABSTRACT

The lamp provided in the disclosure includes: a lamp body, a light source and a switch device for controlling the light source, wherein the lamp body forms an installation space and an opening of the installation space, the light source is provided in the installation space and faces towards the opening, the lamp has an exposed portion, and the opening is located at the exposed portion; the switch device is provided in the installation space, and a trigger end of the switch device is provided towards the opening; or the switch device is provided at the opening or adjacent to the opening, and the trigger end of the switch device is exposed outside the exposed portion. The user only needs to detach some components of the exposed portion to expose the trigger end of the switch device, and the user is able to also perform direct observation and operation.

### CROSS-REFERENCE TO RELATED APPLICATION

The disclosure claims the benefit of priority to Chinese Patent Application No. 202320075684.6, filed with the Chinese Patent Office on Jan. 9, 2023 and entitled “Lamp”, which is incorporated in its entirety herein by reference.

### TECHNICAL FIELD

The disclosure relates to the technical field of lamps, and specifically relates to a lamp with an improved switch position, and in particular to a lamp that needs to be installed at the top or upper part of a space and irradiates downwards, such as a down lamp, a ceiling lamp and a pendant lamp.

### BACKGROUND

An existing down lamp includes a lamp body, a light-emitting LED module and a switch device; the lamp body has an upper wall and a peripheral wall which extends downwardly from the edge of the upper wall and gradually expands outwardly, and an installation space for the lamp body and a downward-facing opening for the installation space are formed between the lower part of the upper wall and the inner periphery of the peripheral wall, the opening is located at an exposed portion of the down lamp, i.e. located at a lower surface of the down lamp; the light-emitting LED module includes a plurality of light-emitting LEDs which are arranged in an array on a circuit board, the circuit board is fixed on a lower side surface of the upper wall of the lamp body; and the light-emitting LEDs face towards the opening of the lamp body and face downwards.

A switch device is used for controlling the light-emitting LEDs, and includes a switch device for controlling the light-emitting LEDs and adjusting optical features or switching a function. Generally, the switch device is arranged on the back part of the lamp body, i.e. above the upper wall of the lamp body; and after the down lamp is installed on a ceiling, the switch device is in an untouchable position, and when turning on/off or color temperature adjustment is required, the down lamp needs to be detached, which is inconvenient to operate.

### SUMMARY

Some embodiments of the disclosure provide a lamp capable of achieving turning on/off or adjustment control on the lamp without detaching the whole lamp, so that an operation process is more intuitive, and operation accuracy and stability are ensured.

The lamp provided in some embodiments of the disclosure includes: a lamp body, a light source and a switch device, wherein the light source is connected to the lamp body, the lamp body forms an installation space and an opening of the installation space, the lamp has an exposed portion, and the opening is located at the exposed portion; the switch device is provided in the installation space, and a trigger end of the switch device is provided towards the opening; or the switch device is provided at the opening or adjacent to the opening, and the trigger end of the switch device is exposed outside the exposed portion.

It is determined from the solution that, in this arrangement, no matter whether the switch device is arranged at the opening, adjacent to the opening or arranged in the installation space, the trigger end of the switch device, such as a shift gear or a key, or corresponding character information face towards a user. Under this premise, the trigger end exposed outside the exposed portion is used for direct observation and direct operation by the user, and when the switch device is arranged in the installation space, the user only needs to detach some components of the exposed portion to expose the trigger end of the switch device, and the user is able to also perform direct observation and operation.

In an embodiment mode, the switch device is provided in the installation space, and a trigger end of the switch device is provided towards the opening; the lamp includes a detachable shielding member, and after the shielding member is detached, the trigger end is exposed to the exposed portion.

Hence, the user only needs to detach the shielding member to expose the trigger end of the switch device, and the user is able to perform direct observation and direct operation.

In an embodiment mode, the shielding member is a light-transmitting member, a light-reflecting member or a light-shielding member.

In an embodiment mode, the shielding member includes a reflector cup, the reflector cup is installed in the installation space and is blocked between the switch device and the opening, and after the reflector cup is detached, the trigger end is exposed to the exposed portion; or the shielding member includes a lamp shade, the lamp shade is installed at the opening and shields the switch device, and after the lamp shade is detached, the trigger end is exposed to the exposed portion.

Hence, for a lamp, in order to facilitate inspection and assembly of a light source, a light-transmitting plate, a light-reflecting shade, a light-shielding shade, and the like in cooperation with the light source are generally configured to be detachable; therefore, only a slight change of the detachable manner is required, and these original and detachable components are used to shield the switch device, so that the increase of the number of lamp components is avoided.

In an embodiment mode, the shielding member includes a surface cover, the surface cover is detachably installed at the opening and shields the switch device, and after the surface cover is detached, the trigger end is exposed to the exposed portion.

In an embodiment mode, the lamp includes a first lamp shade, a second lamp shade and a surface cover, wherein the first lamp shade, the second lamp shade and the surface cover are all installed at the opening, the second lamp shade is located on an outer peripheral side of the first lamp shade, the surface cover is located at a center of the first lamp shade, the surface cover shields the switch device, and after the surface cover is detached, the trigger end is exposed to the exposed portion.

In an embodiment mode, the surface cover is made of a light-transmitting material, so that light is able to pass through the surface cover to be emitted, and the surface cover forms a complete light-emitting surface together with the first lamp shade and the second lamp shade, thereby preventing a black shadow from being generated at the surface cover.

In an embodiment mode, an installation base is further provided at the center of the first lamp shade, and a first position and a second position are formed in an inner space of the installation base, the first position is located above the second position, the first position has an inlet, and the second position has an outlet; a main body of the switch device is accommodated in the first position, and the trigger end of the switch device passes through a retaining wall of the installation base and reaches the second position, and the surface cover is detachably installed at the outlet and shields the second position.

In an embodiment mode, both the installation base and the surface cover are made of a light-transmitting material.

In an embodiment mode, the lamp further includes a switch handle, and the switch handle is arranged in an extension direction of the trigger end, an end of the switch handle protrudes out of the opening and is exposed outside an outer side of the shielding member; or the switch device is connected to the shielding member by the switch handle, wherein the shielding member shields the switch handle.

In an embodiment mode, the shielding member is provided in the installation space, or the shielding member is provided at the opening.

Hence, the shielding member may be a light-reflecting shade arranged in the installation space, is a blocking cover arranged at the opening, or a light-transmitting plate arranged at the opening.

In an embodiment mode, the lamp further includes a linkage assembly movably arranged, wherein a part of the linkage assembly is located in the exposed portion, and the linkage assembly is in linkage cooperation with the trigger end.

Hence, for some trigger ends with a relatively high operating frequency, such as trigger ends corresponding to turning on/off and color temperature adjustment, a linkage assembly may be added, and the user is able to control the switch device by the linkage assembly, thereby further reducing the operation difficulty.

In an embodiment mode, the trigger end is a press-type trigger end; and the linkage assembly is able to move in a pressing direction of the press-type trigger end.

Hence, as the trigger end faces towards the opening, the trigger end is set to be a press type, and the user is able to trigger the trigger end by pushing up the linkage assembly; and with this arrangement, the user operation is simpler, and meanwhile, the linkage assembly has a simple design.

In an embodiment mode, the linkage assembly includes a light-transmitting member, a light-reflecting member, a light-shielding member, or a decorative member.
the switch device is located inside the installation space and is arranged in a middle thereof, the linkage assembly includes a linkage member installed in the installation space and a lamp shade provided in the exposed portion, the lamp shade shields the opening; and after being subjected to an acting force, the lamp shade is able to force the linkage member to move to a position where the trigger end is touched.

In an embodiment mode, the linkage assembly includes a linkage member installed in the installation space and a lamp shade arranged on the exposed portion, the linkage member is long-strip member, a cylinder member or a reflector cup; and the linkage member is movably arranged, the linkage member is fixedly connected to the lamp shade, and after being subjected to an acting force, the lamp shade is able to force the linkage member to move to a position where the trigger end is touched.

Hence, the linkage assembly is designed by means of existing components, for example, a tubular reflector cup and a lamp shade or a light-transmitting plate located at the opening need to be provided in the lamp body, the reflector cup and the lamp shade are configured to be able to float vertically to serve as the linkage assembly, and the user pushes up the lamp shade so that the reflector cup touches the trigger end; of course, some decorative components in the exposed portion of the lamp is able to also serve as the linkage assembly. This arrangement achieves linkage of the switch device without additionally providing large-volume components.

In an embodiment mode, the linkage member is a long-strip member, a switch handle, a cylinder member or a reflector cup.

In an embodiment mode, the lamp shade is an anti-dazzle shade with an elastic ear edge; the elastic ear edge is located inside the lamp body and abuts against an inner wall of the lamp body; and after being subjected to an acting force, the lamp shade is able to force the linkage member to move to a position where the trigger end is touched.

In an embodiment mode, a surface of the anti-dazzle shield is formed by sequentially connecting a plurality of annular anti-dazzle surfaces of different diameters along the extension direction of the switch handle, and the diameter of the annular anti-dazzle surfaces gradually increases in the direction close to the opening.

In an embodiment mode, the lamp shade has a protruding portion for abutting against the switch device, the linkage member is the protruding portion, and vertical displacement is generated by using a deformation amount of the elastic ear edge, and the switch device is triggered by the protruding portion.

In an embodiment mode, the lamp includes a plurality of light sources, the plurality of light sources including at least two light sources; a light-emitting region is formed in the installation space, and the plurality of light sources are arranged corresponding to the same light-emitting region; or, the lamp further includes a partition member, wherein the partition member partitions the installation space into at least two light-emitting regions, and the plurality of light sources respectively correspond to the plurality of light-emitting regions.

From the described solutions, it is determined that for example, the lamp includes a first light source for illumination use and a second light source for decorative use, and under this arrangement, the light-emitting surfaces of two light-emitting regions provided are both in the lower exposed portion of the lamp and are partitioned to be independent from each other, and a variety of light requirements is satisfied in combination with system control.

In an embodiment mode, the partition member is in a surrounding shape, and the partition member partitions the installation space into an inner peripheral light-emitting region and an outer peripheral light-emitting region located on the outer periphery of the inner peripheral light-emitting region.

Hence, this arrangement enables the irradiation ranges of the two light-emitting regions to have better coverage, and ensures the light effect.

In an embodiment mode, the partition member includes a light-transmitting member, a light-reflecting member or a light-shielding member.

Hence, this arrangement is able to realize partitioned arrangement of the light sources without additionally providing large-volume components.

In an embodiment mode, the lamp is a down lamp, the down lamp includes a connection structure matching a lamp tube, the connection structure includes a connection base and a spring frame which are located on the lamp body; the spring frame is rotatably connected to the connection base, or the spring frame is detachably connected to the connection base.

Hence, the down lamp is packaged in a folded or detached form, and the spring frame is overturned outwardly or assembled when the down lamp needs to be installed to the lamp tube.

The spring frame of the both two arrangements is able to reduce the height of the lamp body, reduce the space required for packaging, and reduce costs.

In an embodiment mode, the spring frame is bent to form an insertion tongue, an insertion port is provided on the connection base, and the insertion tongue is detachably inserted into the insertion port.

Hence, a linear insertion form makes the detachment and assembly of the spring frame easier.

### BRIEF DESCRIPTION OF THE DRAWINGS

FIG. 1 is a sectional view of a first embodiment of a lamp according to some embodiments of the disclosure.

FIG. 2 is a sectional view of a second embodiment of a lamp according to some embodiments of the disclosure.

FIG. 3 is a sectional view of a third embodiment of a lamp according to some embodiments of the disclosure.

FIG. 4 is a sectional view of a fourth embodiment of a lamp according to some embodiments of the disclosure.

FIG. 5 is a sectional view of a fifth embodiment of a lamp according to some embodiments of the disclosure.

FIG. 6 is a sectional view of a sixth embodiment of a lamp according to some embodiments of the disclosure.

FIG. 7 is a sectional view of a seventh embodiment of a lamp according to some embodiments of the disclosure.

FIG. 8 is a sectional view of a eighth embodiment of a lamp according to the disclosure.

FIG. 9 is a structural diagram of a first state of the first embodiment of the lamp according to some embodiments the disclosure.

FIG. 10 is a structural diagram of a second state of the first embodiment of the lamp according to some embodiments the disclosure.

FIG. 11 is a structural diagram of a first state of a ninth embodiment of a lamp according to some embodiments of the disclosure.

FIG. 12 is a structural diagram of a second state of a ninth embodiment of a lamp according to some embodiments of the disclosure.

FIG. 13 is a sectional view of a tenth embodiment of a lamp according to some embodiments of the disclosure.

FIG. 14 is a sectional view of an eleventh embodiment of a lamp according to some embodiments of the disclosure.

FIG. 15 is a sectional view of a twelfth embodiment of a lamp according to some embodiments of the disclosure.

FIG. 16 is a sectional view of a thirteenth embodiment of a lamp according to some embodiments of the disclosure.

FIG. 17 is a sectional view of a fourteenth embodiment of a lamp according to some embodiments of the disclosure.

The figures above include the following reference signs:
10. Opening; 100. Installation space; 101. Inner peripheral light-emitting region; 102. Outer peripheral light-emitting region; 103. First position; 104. Second position; 109. Exposed portion; 11. Lamp body; 111. Upper wall; 112. Peripheral wall; 12. Reflector cup; 131. First lamp shade; 132. Second lamp shade; 1310. Outlet; 1311. Installation base; 1312. Retaining wall; 14. Surface cover; 15. Radiator; 151. Wall body; 16. Light-emitting module; 161. First LED lamp group; 162. Second LED lamp group; 17. Connection structure; 171. Connection base; 172. Spring frame; 1711. First connection end; 1712. Second connection end; 1721. Spring portion; 1722. Arm portion; 19. Switch device; 191. Trigger end;
210. Installation position;
319. First knob; 329. Second knob;
43. Lamp shade; 431. Anti-dazzle surface; 433. Elastic ear edge; 434. Protruding portion; 48. Elastic member;
810. Insertion port; 823. Insertion tongue;
90. Switch handle; 92. Side spring; 93. Terminal box;

### DETAILED DESCRIPTION OF THE EMBODIMENTS

### First Embodiment of Lamp

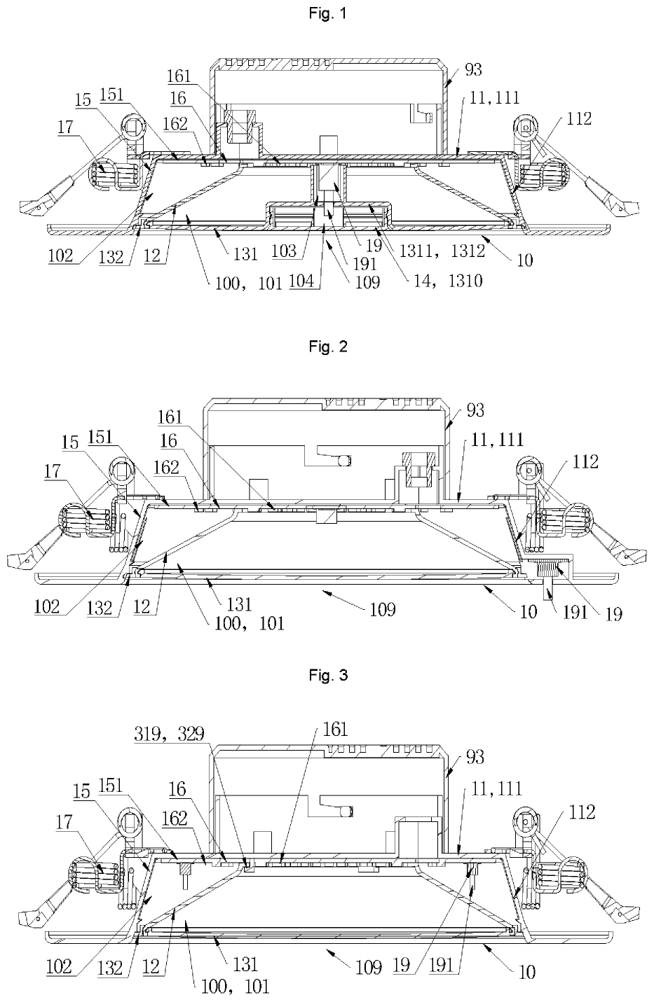

Referring to FIG. 1, this embodiment relates to a down lamp; the down lamp includes a lamp body 11, a reflector cup 12, a first lamp shade 131, a second lamp shade 132, a surface cover 14, a radiator 15, a light-emitting module 16, a connection structure 17, a terminal box 93, a side spring 92, and a switch device 19.

The lamp body 11 includes an upper wall 111 and a peripheral wall 112 which extends downwardly from a circular edge of the upper wall 111 and gradually expands outwardly; an installation space 100 for the lamp body 11 and a downward-facing opening 10 for the installation space 100 are formed between the lower part of the upper wall 111 and the inner periphery of the peripheral wall 112. The terminal box 93 is provided on the side of the upper wall 111 away from the opening 10, and the side spring 92 is connected to a side portion of the lamp body 11.

As shown in FIG. 1, the down lamp is embedded into a lamp tube in a ceiling and irradiates light below the lamp tube, one side facing downwards of the lamp tube is an exposed portion 109 of the down lamp, and the exposed portion 109 is exposed after the down lamp is installed. The opening 10 of the lamp body 11 faces downwards and is located on the exposed portion 109. The outer contour of the radiator 15 matches the inner contour of the lamp body 11, the radiator 15 is installed in the installation space 100 and is attached to an inner wall of the lamp body 11, and one wall body 151 of the radiator 15 is connected to the lower surface of the upper wall 111.

The light-emitting module 16 includes a circuit board, and a first LED lamp group 161 and a second LED lamp group 162 which are connected to the circuit board; the circuit board of the light-emitting module 16 is connected to the wall body 151 of the radiator 15, the first LED lamp group 161 and the second LED lamp group 162 face downwards, and the first LED lamp group 161 and the second LED lamp group 162 are respectively different types of light sources in some embodiments of the disclosure; and the switch device 19 is connected to the circuit board, the switch device 19 has a shift gear, the shift gear faces downwards and is arranged facing towards the opening 10, and the shift gear is a trigger end 191 of some embodiments of the disclosure.

The lamp in some embodiments of the disclosure further includes a partition member which partitions the installation space 100 into at least two light-emitting regions. A plurality of light sources respectively correspond to a plurality of light-emitting regions. In this way, different light-emitting regions may have different display effects, thereby increasing the display richness of the lamp. In addition, the partition member further includes multiple options such as a light-transmitting member, a light-reflecting member or a light-shielding member.

In this embodiment, the partition member is specifically provided in the form of the reflector cup 12.

The reflector cup 12 in a horn shape is fixedly installed in the installation space 100, such that the installation space 100 is partitioned into an inner peripheral light-emitting region 101 located in the middle and an outer peripheral light-emitting region 102 annularly surrounding an outer periphery of the inner peripheral light-emitting region 101; wherein the first LED lamp group 161 serving as a main lamp for illumination use is provided corresponding to the inner peripheral light-emitting region 101, and the second LED lamp group 162 serving as a decorative lamp for decorative use or for night-light use is provided corresponding to the outer peripheral light-emitting region 102.

In another embodiment, the partition member is a light-transmitting member or a light-shielding member, in other embodiments, the reflector cup 12 is replaced with a cup-body structure formed of a transparent or translucent light-transmitting material, so that the inner peripheral light-emitting region 101 and the outer peripheral light-emitting region 102 are portioned only by the cup-body structure, but light is able to pass through the cup-body structure. Or, the reflector cup 12 is replaced with a cup-body structure made of a light-shielding material, so that the inner peripheral light-emitting region 101 and the outer peripheral light-emitting region 102 are partitioned by the cup-body structure and light cannot pass through the cup-body structure.

The first lamp shade 131 and the second lamp shade 132 are light-transmitting members for transmitting light. The light-transmitting members herein do not refer to the light-transmitting member mentioned in the partition member above, but simply represent that the first lamp shade 131 and the second lamp shade 132 are used for transmitting light. In addition, the first lamp shade 131 and the second lamp shade 132 constitute the whole lamp shade together.

In this embodiment, the first lamp shade 131 is arranged corresponding to the inner peripheral light-emitting region 101 and is fixedly installed on the inner periphery of the reflector cup 12 and located at the opening 10; while the second lamp shade 132 is annular and is fixedly installed between the outer periphery of the reflector cup 12 and the inner periphery of the lamp body 10 and is also located at the opening 10. Further, an installation base 1311 is further arranged at a center of the first lamp shade 131, and an outer peripheral wall of the installation base 1311 enables an inner space of the installation base to be independent of the inner peripheral light-emitting region 101; furthermore, the inner space of the installation base 1311 forms a first position 103 located above and having a relatively small inner diameter, and a second position 104 located below and having a relatively large inner diameter, wherein the first position 103 has an inlet facing upwards, and the second position 104 has an outlet 1310 facing downwards; and a main body of the switch device 19 is accommodated in the first position 103, the shift gear of the switch device 19 passes through a retaining wall 1312 of the installation base 1311 and reaches the second position 104.

In some embodiments of the disclosure, the lamp includes a detachable shielding member, and after the shielding member is detached, the switch device is exposed to a surface side 109. In different embodiments, the shielding member may have multiple options, and may be one of a light-transmitting member, a light-reflecting member and a light-shielding member.

In this embodiment, the surface cover 14 is selected as a shielding member, and the surface cover 14 is detachably installed at the outlet 1310 in a snap-fit manner and shields the second position 104. Since the outlet 1310 is located at the opening 10 and at the exposed portion 109, the shift gear of the switch device 19 is exposed to the exposed portion 109 once the surface cover 14 is detached. Hence, a user is able to directly control the switch device 19 merely by detaching the surface cover 14. Further, referring to FIG. 1, the surface cover 14 is actually detachably installed at the center of the first lamp shade 131 of the corresponding main lamp, i.e. the center of a light-exit surface; in order to prevent a dark shadow at the center, affecting the illumination effect and affecting the aesthetics, the installation base 1311 and the surface cover 14 are both made of a light-transmitting material, so that light is emitted from the center of the exit surface, and thus the light-emitting surface of the whole main lamp has good integrity. As the surface cover 14 is made of a light-transmitting material, the shielding member in the embodiment is actually a light-transmitting member. Certainly, in other embodiments, a reflector cup or a lamp shade is selected as the shielding member.

In FIG. 1, only one shift gear is schematically shown, and actually, a plurality of trigger ends 191 may be provided according to the number of control types. For example, optical features which are adjusted by the switch device in some embodiments of the disclosure include but are not limited to, color temperature, brightness and power, etc., and function modes which are adjusted by the switch device include but are not limited to, illumination switching between the main lamp and the decorative lamp and controlling both lamps to be turned on, for example, when the switch device is operated once, the first LED lamp group 161 is turned off while the second LED lamp group 162 is turned on.

Furthermore, the trigger end 191 of the switch device may not only be a shift gear, but also a key or a knob. For example, in this embodiment, the shift gear is used for controlling the color temperature of the first LED lamp group 161, a shift gear for controlling the color temperature of the second LED lamp group 162 may be added, a multi-gear shift button for selecting a preset lamp effect mode may be added, a button for controlling the on/off of the first LED lamp group 161 or the second LED lamp group 162 may be added, and the shift gear is replaced with a pullable knob. Before being pulled, the knob is connected to a first circuit, so that the color temperature of the first LED lamp group 161 is adjusted in a stepless manner; and after being pulled, the knob is disconnected from the first circuit and is connected to a second circuit, so that the color temperature of the second LED lamp group 162 is adjusted in a stepless manner. Further, the lower surface of the retaining wall 1312 is printed with characters or patterns matching different gears of the shift gear for user discrimination.

Hence, under the effect of some embodiments of the disclosure, when adjusting the lamp effect, it is unnecessary to detach the whole lamp, in particular, when there are two or more types of light sources of the lamp and two or more trigger ends 191 are required for an effect to be adjusted, a manner of exposing the plurality of trigger ends 191 of the switch device to the exposed portion in some embodiments of the disclosure is used for direct observation and direct operation by the user. Compared with a manner of indirectly operating the trigger ends 191 by a linkage structure, some embodiments of the disclosure is able to reduce operation difficulty and ensure operation accuracy due to direct observation and direct operation.

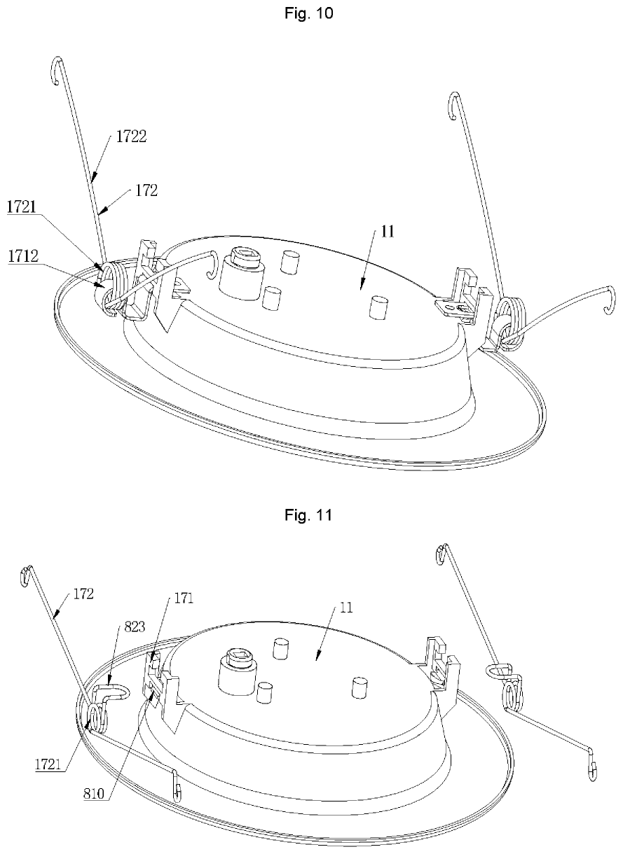

In addition, referring to FIGS. 9 and 10, the present embodiment further includes a connection structure for connecting the down lamp to the lamp tube; the connection structure includes a connection base 171 and a spring frame 172, the connection base 171 is a metal member and includes a first connection end 1711 and a second connection end 1712, wherein the first connection end 1711 is fixed to the lamp body 11 by a bolt, and the second connection end 1712 is bent to be annular. The spring frame 172 includes a spring portion 1721 and arm portions 1722; two arm portions 1722 protrude in an opposite direction from two ends of the spring portion 1721 and are V-shaped. The spring portion 1721 passes through the annular second connection end 1712, so that the spring frame 172 is able to rotate by taking the second connection end 1712 as the center, thereby changing the spring frame 172 between a use state and a folded state. The main purpose of this arrangement is to reduce the space required for packaging and reduce costs.

### Second Embodiment of Lamp

Referring to FIG. 2, in this embodiment, the lamp body 11 is provided with an installation position 210 on the outer periphery of the opening 10 of the lamp body, the main body of the switch device 19 is installed in the installation position 210, and the shift gear of the switch device 19 extends downwards out of the lamp body 11 and is exposed outside of the exposed portion 109. The shift gear is the trigger end 191.

Compared with the first embodiment, in the present embodiment, the shift gear is directly operated without detaching components, thereby further reducing the operation amount of the user, and making the operation of lamp effect adjustment simpler.

In other embodiments, the switch device is also provided in such a manner that the trigger end 191 thereof is exposed outside of the exposed portion, but other embodiments differ from the second embodiment in that: the switch device is arranged at a center of the opening, or other positions in the opening, or other positions adjacent to the opening.

### Third Embodiment of Lamp

Referring to FIG. 3, same as the first embodiment, the present embodiment also exposes the switch device in the installation space by detaching the shielding member. Different from the first embodiment, in this embodiment, the switch device 19 is fixed in the outer peripheral light-emitting region 102, and the reflector cup 12 is installed in the installation space and blocked between the switch device 19 and the opening 10. Detaching of the reflector cup 12 is able to allow the switch device 19 and a push lever 191 thereof to be exposed at the exposed portion 109 through the opening 10. Of course, the shift gear of the present embodiment likewise faces downwards and faces towards the opening 10. The shift gear is the trigger end 191.

In order to facilitate detachment of the reflector cup 12, the lamp body 11 and the reflector cup 12 are respectively provided with a first knob 319 and a second knob 329, the rotation of the reflector cup 12 relative to the lamp body 11 enables the first knob 319 and the second knob 329 to be switched between an engaged state and a disengaged state. When the first knob 319 and the second knob 329 are in an engaged state, they is able to limit each other vertically, and therefore, the user is able to easily detach the reflector cup 12 by only rotating the reflector cup 12.

That is to say, in this embodiment, the reflector cup 12 serves as a shielding member for shielding the switch device 19.

### Fourth Embodiment of Lamp

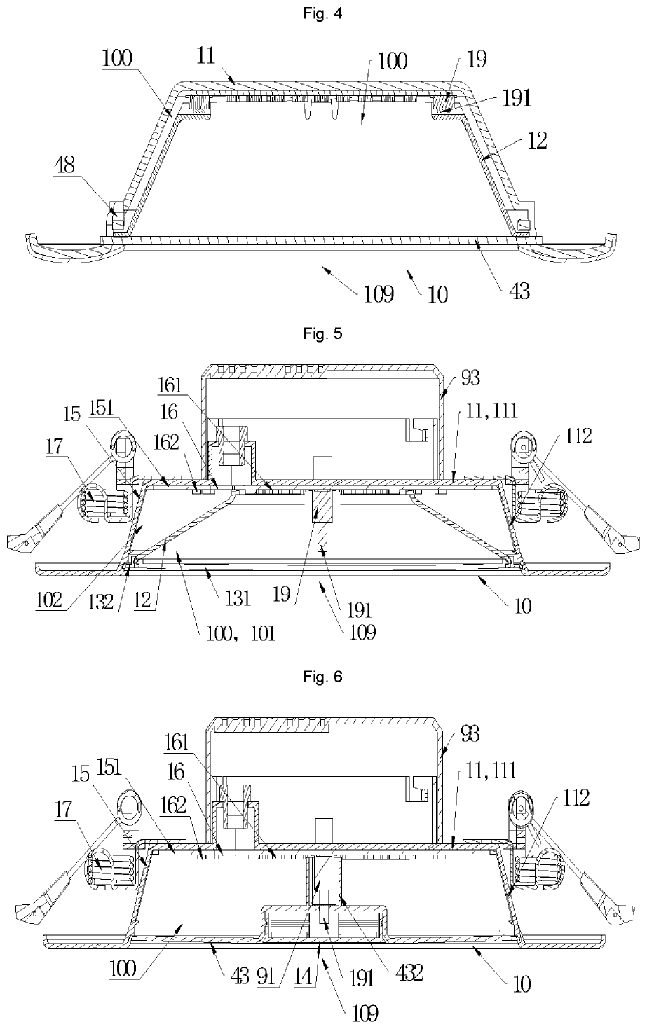

Referring to FIG. 4, similar to the third embodiment, in the present embodiment, the switch device 19 is also fixed in the installation space 100 and the trigger end 191 thereof faces towards the opening 10 of the lamp body 11. Different from the three embodiments above, switch devices 19 of the present embodiment are not exposed outside the exposed portion 109 and cannot be exposed at the exposed portion 109, but the switch devices is indirectly operated by a linkage assembly.

The trigger end 191 of each switch device 19 is a reboundable button, the button is a press-type trigger end 191 in some embodiments of the disclosure, and the pressing direction of the button is vertical. In this embodiment, the reflector cup 12 is provided in a form of being vertically arranged and limited to be movable within a certain stroke. In this embodiment, elastic members 48 vertically arranged are added between the lamp body 11 and the reflector cup 12. Since the reflector cup 12 is able to float up and down, the reflector cup 12 is able to abut against the button after moving upwards, and the user only needs to press a lamp shade 43 from the front, the lamp shade 43 and the reflector cup 12 is able to float up and touch the button. The reflector cup 12 and the lamp shade 43 constitute the linkage assembly in some embodiments of the disclosure.

Further, as shown in FIG. 4, one switch device 19 is arranged on each of the left and right sides of the installation space 100; furthermore, the elastic members 48 are provided on both the left and right sides of the lamp, and the reflector cup 12 is not limited to a form that is able to merely float up or descend as a whole. That is, when the user applies an acting force to one side of the lamp shade 43, only one side of the reflector cup 12 is able to float up while the other side remains unchanged, thereby only triggering one specific switch device 19. Therefore, in the present embodiment, even if the switch devices are not exposed and cannot be exposed, independent control of two or even multiple switch devices is achieved without detaching any component.

In addition, in this embodiment, only one unique light-emitting region and one light source are included.

### Fifth Embodiment of Lamp

Referring to FIG. 5, same as the first embodiment, the installation space 100 of the present embodiment is also partitioned into an inner peripheral light-emitting region 101 and an outer peripheral light-emitting region 102 by the reflector cup 12. This embodiment differs from the first embodiment in that: in the present embodiment, the first lamp shade 131 is plate-shaped and does not have an installation base, the switch device 19 located at a center of the installation space is located in the inner peripheral light-emitting region 101; and after the first lamp shade 131 is detached, the switch device 19 and the shift gear thereof are exposed to and located at the exposed portion 109 through the opening 10.

That is to say, in this embodiment, the first lamp shade 131 serves as a shielding member for shielding the switch device 19.

In addition, if it is not explicitly distinguished whether a lamp shade is a first lamp shade or a second lamp shade, the lamp shade mentioned in some embodiments of the disclosure generally refers to the lamp shade 43.

### Sixth Embodiment of Lamp

Referring to FIG. 6, this embodiment differs from the first embodiment in that: in the present embodiment, no reflector cup is provided, and thus the installation space 100 thereof only forms one single light-emitting region. Same as the first embodiment: the switch device 19 and the shift gear thereof in this embodiment are also arranged independently of the light-emitting region by the installation base 1311 on the lamp shade 43, and after the surface cover 14 is detached, the shift gear is exposed to the exposed portion.

### Seventh Embodiment of Lamp

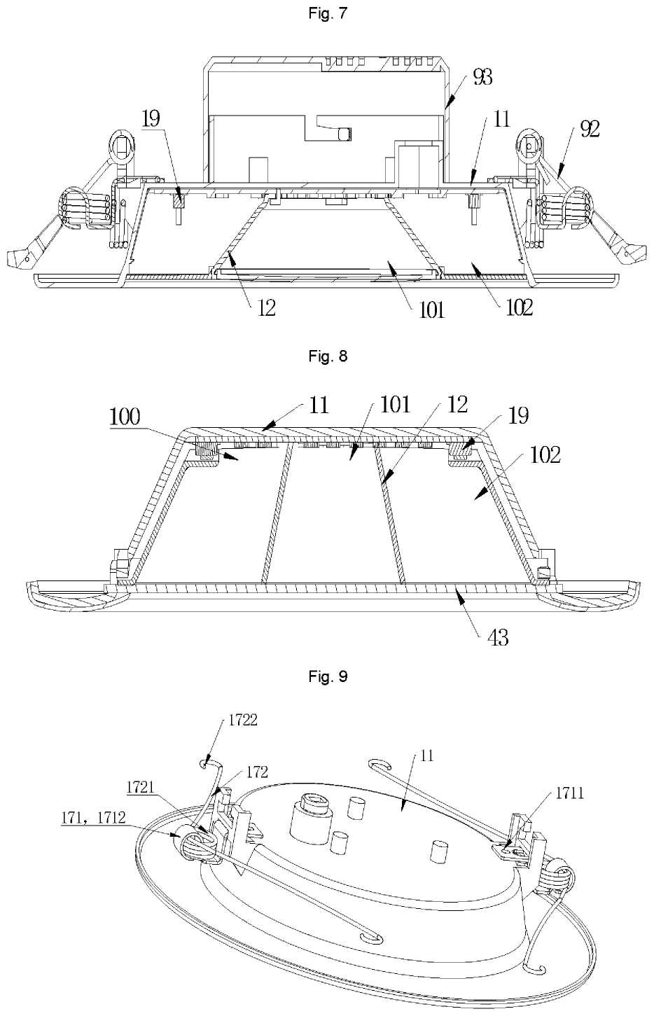

Referring to FIG. 7, this embodiment is similar to the third embodiment, but in comparison with the third embodiment, the reflector cup 12 has a small outward-expanding extent, thereby forming a small inner peripheral light-emitting region 101 and a large outer peripheral light-emitting region 102.

### Eighth Embodiment of Lamp

Referring to FIG. 8, this embodiment differs from the fourth embodiment in that: in this embodiment, another reflector cup 12 is added, and the newly added reflector cup 12 is arranged inside the original reflector cup 12, so that the internal space of the outer-side reflector cup 12 is further partitioned, thereby forming an outer peripheral light-emitting region 102 located between the two reflector cups 12 and an inner peripheral light-emitting region 101 located inside the inner-side reflector cup 12.

### Ninth Embodiment of Lamp

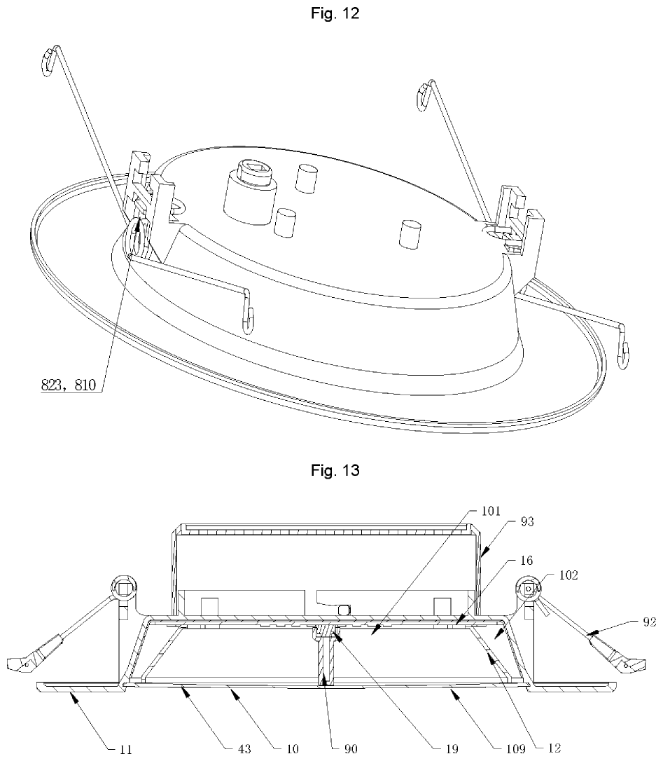

Referring to FIGS. 11 and 12, in this embodiment, the spring frame 172 is arranged in a detachable form. A connection base 171 is formed on the lamp body 11, the connection base 171 has an insertion port 810 located on the outer periphery of the lamp body 11 and extending in a substantially horizontal direction, and the spring frame 172 bends a part of the spring portion 1721 thereof to form an insertion tongue 823. The insertion tongue 823 is inserted into the insertion port 810 to complete the installation of the spring frame 172, and during packaging, the spring frame 172 is detached and the spring frame 172 is placed horizontally, which is able to reduce the space required for packaging and reduce costs.

### Tenth Embodiment of Lamp

Referring to FIG. 13, similar to the third embodiment, in the present embodiment, the switch device 19 is also fixed in the installation space 100 and the trigger end 191 thereof faces towards the opening 10 of the lamp body 11, and the switch device 19 is located in a middle of the installation space 100. The shielding member is provided at the opening 10, so that the switch device 19 within the installation space 100 is shielded.

This embodiment differs from the third embodiment in that: the switch device 19 of the present embodiment is not arranged in the outer peripheral light-emitting region 102, the reflector cup 12 is installed in the installation space 100, and the switch device 19 is located inside the reflector cup 12 and is arranged in the middle.

In order to facilitate operation, this embodiment further provides a switch handle 90, and the switch handle is arranged in an extension direction of the trigger end 191. In this embodiment, the switch handle 90 is used to associate the switch device 19 with the shielding member; as the shielding member shields the opening 10, the switch handle 90 and the switch device 19 cannot be seen directly from the opening 10. The shielding member and the switch handle 90, as a whole, serve as a linkage assembly, and the switch handle 90 serves as a linkage member; by lightly pressing a middle part of the shielding member and using elastic deformation of the shielding member, a middle region of the shielding member moves, and the switch device 19 is lightly touched by the switch handle 90, thereby realizing color temperature switching, and being more convenient and fast.

That is to say, the switch device 19 is not exposed to the outside of the lamp, but is indirectly operated by the linkage assembly.

Specifically, the trigger end 191 of the switch device 19 has a rebounding function, and thus the switch handle 90 is able to rebound into place even after the trigger disappears, and the pressing direction of the switch handle is a vertical direction.

Specifically, the shielding member is the lamp shade 43. The user only needs to press the lamp shade 43 from the front face, so that the lamp shade 43 is able to float up and touch the switch handle. For ease of operation, the position of the lamp shade 43 close to the switch handle is relatively thin, and other positions are relatively thick.

Further, the lamp shade 43 is a diffusion cover having a diffusion function.

### Eleventh Embodiment of Lamp

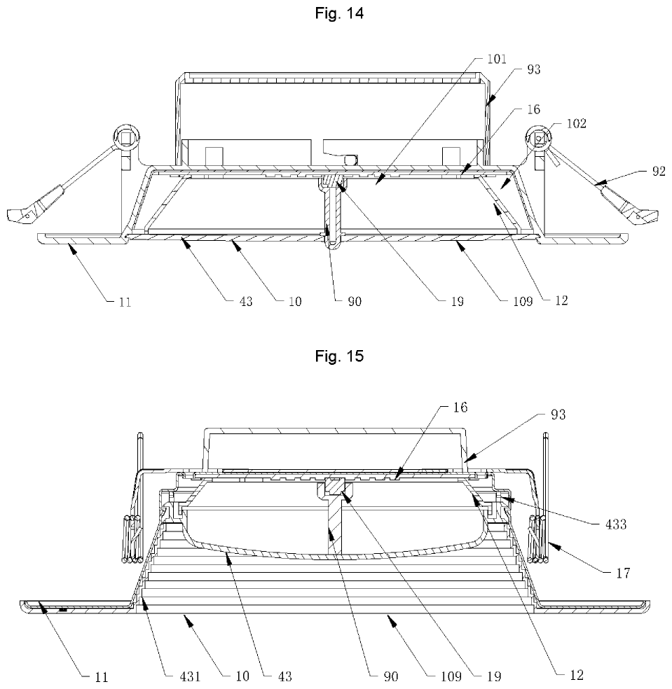

Referring to FIG. 14, this embodiment differs from the tenth embodiment in that: in this embodiment, the length of the switch handle 90 is longer, an end of the switch handle 90 protrudes out of the opening 10 and is exposed outside the shielding member (the lamp shade 43), and the end of the switch handle 90 is seen from the bottom of the lamp.

In this way, the user is able to directly lightly press the end of the switch handle 90, and trigger the switch device 19 by the switch handle 90, thereby implementing color temperature switching (which may also be other types of control switches, for example, switches for adjusting brightness and switching functions), which is more convenient and fast.

That is to say, the switch handle 90 serves as a linkage assembly and is exposed outside the opening 10, and the user is able to directly operate the switch handle 90 without triggering the switch handle 90 by pressing the lamp shade 43.

In addition, improvement may also be made on the basis of the third embodiment, the switch device 90 is arranged near the peripheral wall 112 of the lamp body 11, and the switch handle 90 is exposed out of the opening 10, and a figure will not be added here.

### Twelfth Embodiment of Lamp

Referring to FIG. 15, same as the tenth embodiment: the switch handle 90 is also arranged between the switch device 19 and the lamp shade 43, the switch handle 90 associates the switch device 19 with the lamp shade 43; as the lamp shade 43 shields the opening 10, the switch handle 90 and the switch device 19 cannot be seen directly from the opening 10. The lamp shade 43 and the switch handle 90, as a whole, serve as a linkage assembly; and by lightly pressing a middle part of the lamp shade 43 and using elastic deformation of the lamp shade 43, the switch handle 90 is driven to trigger the switch device 19, thereby realizing color temperature switching, and being more convenient and fast.

This embodiment differs from the tenth embodiment in that: the structure of the lamp shade 43 in this embodiment is different from that in the tenth embodiment.

In this embodiment, the lamp shade 43 is an anti-dazzle shade having an elastic ear edge 433. The elastic ear edge 433 is located inside the lamp body 11 and abuts against the inner wall of the lamp body 11; when the middle part of the lamp shade 43 is lightly pressed, vertical displacement is generated by using a deformation amount of the elastic ear edge 433, and the switch handle 90 is pushed to trigger the switch device 19.

In addition, it can be seen from FIG. 15 that the anti-dazzle shade has a certain depth, and the surface of the anti-dazzle shade is formed by sequentially connecting a plurality of annular anti-dazzle surfaces 431 of different diameters along the extension direction of the switch handle 90. The diameter of the annular anti-dazzle surfaces 431 gradually increases in the direction close to the opening 10.

### Thirteenth Embodiment of Lamp

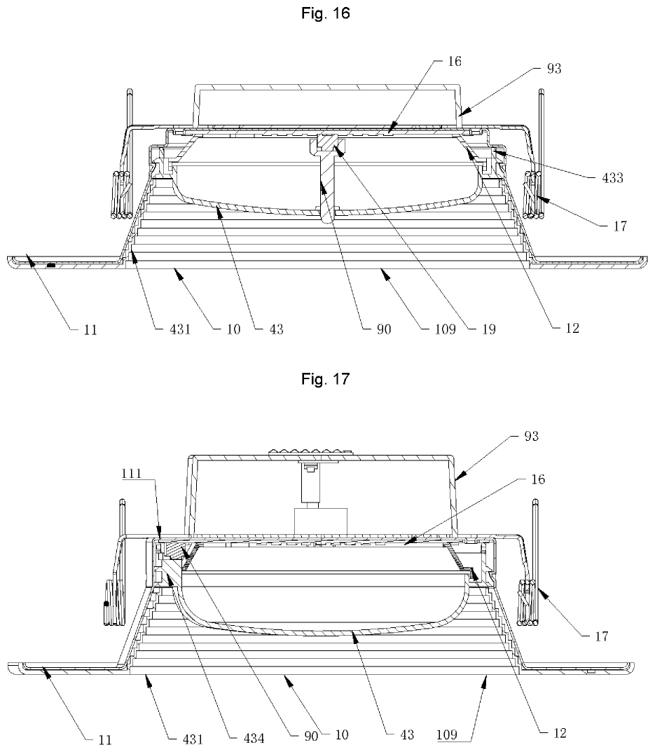

Referring to FIG. 16, this embodiment differs from the twelfth embodiment in that: in this embodiment, the length of the switch handle 90 is longer, an end of the switch handle 90 is exposed outside the lamp shade 43, and the end of the switch handle 90 can be seen from the bottom of the lamp.

In this way, the user is able to directly lightly press the end of the switch handle 90, and trigger the switch device 19 by the switch handle 90, thereby implementing color temperature switching (which is other types of control switches, for example, switches for adjusting brightness and switching functions), which is more convenient and fast.

That is to say, the switch handle 90 serves as a linkage assembly and is exposed outside the opening 10, and the user is able to directly operate the switch handle 90 without triggering the switch handle 90 by pressing the lamp shade 43.

In the present embodiment, the lamp shade 43 also uses the same anti-dazzle shade as that in the twelfth embodiment, which will not be repeated here.

### Fourteenth Embodiment of Lamp

Referring to FIG. 17, same as the twelfth embodiment, a lamp shade 43 is also used, and the switch device is also shielded by the lamp shade 43, so that the switch device cannot be seen from the opening 10. However, the structures of the lamp shade 43 are different. In addition, the arrangement positions of the switch device 90 are also different. This results in a change in the portion of the lamp shade 43 matching the switch device 90.

Specifically, the switch device 90 is arranged inside the lamp body and is located at an edge of the upper wall 111, and is no longer arranged at a center of the upper wall 111. Moreover, the lamp shade 43 has a protruding portion 434 for abutting against the switch device 90, and in this way, when the lamp shade 43 is pressed, the lamp shade 43 is able to trigger the switch device 90 via the protruding portion 434. Thus, the protruding portion 434 serves as the linkage member mentioned above.

In addition, the protruding portion 43 needs to be combined with the elastic ear edge in the twelfth embodiment. Vertical displacement is generated by using a deformation amount of the elastic ear edge, and the switch device 90 is triggered by the protruding portion 43. Furthermore, the elastic ear edge may also rebound in time after an external force disappears.

It is determined from the tenth embodiment to the fourteenth embodiment that all these embodiments trigger the switch device 90 via the linkage assembly, and have the following features: 1. The switch device is arranged in the middle of the upper wall 111 or close to the edge of the upper wall. 2. The linkage assembly is able to abut against the inner side of the lamp shade 43 or be exposed outside the opening 10, and in addition, the linkage assembly is able to also be formed at a side edge of the lamp shade 43. 3. The lamp shade 43 may be an anti-dazzle shade with a certain depth.

The exposed portion of the lamp in some embodiments of the disclosure refers to an exposed portion of the lamp after the lamp is installed in a corresponding scenario, for example, in the multiple embodiments above, the exposed portion of a plurality of lamps is mainly the lower side of the lamps. In some embodiments, the exposed portion of the lamp is a stereoscopic portion, and at this time, the exposed portion of the lamp includes the lower side and the outer periphery of the stereoscopic portion. Correspondingly, the opening of the installation space of the lamp body of the lamp is arranged on the outer periphery of the stereoscopic portion above, and the user stretches out his/her hand from the opening on the outer periphery of the stereoscopic portion to touch the trigger end 191 of the switch device, which is able to also complete the lamp effect adjustment operation without detaching the whole lamp.

In other embodiments, the lamp is a ceiling lamp or a pendant lamp. In other embodiments, the portion of the linkage assembly exposed outside the exposed portion is a decorative panel outside the lamp shade.

In other embodiments, a reflector cup is not provided in some lamps, such as a down lamp, and a long-strip member or a cylinder member is additionally provided as a linkage member, the linkage member serves as a part of the linkage assembly of some embodiments of the disclosure.

One end of the linkage member matches the trigger end 191 of the switch device, and the other end of the linkage member is fixedly connected to the lamp shade or a decorative lamp ring located at the exposed portion of the lamp. The user presses the lamp shade or the decorative lamp ring to trigger the linkage member to move, so that the linkage member moves to a position where the trigger end 191 is touched.

Finally, it should be emphasized that the content above merely relates to preferred embodiments of the disclosure, and is not intended to limit the disclosure; for a person skilled in the art, some embodiments of the disclosure may have various changes and modifications. Any modifications, equivalent replacements, improvements, etc. made within the spirit and principle of some embodiments of the disclosure shall all belong to the scope of protection of the disclosure.

What is claimed is:

1. A lamp, comprising: a lamp body, a light source and a switch device, wherein the light source is connected to the lamp body, the lamp body forms an installation space and an opening of the installation space, the lamp has an exposed portion, and the opening is located at the exposed portion;
wherein
the switch device is provided in the installation space, and a trigger end of the switch device is provided towards the opening;
or the switch device is provided at the opening or adjacent to the opening, and the trigger end of the switch device is exposed outside the exposed portion.

2. The lamp according to claim 1, wherein
the switch device is provided in the installation space, and the trigger end of the switch device is provided towards the opening;
the lamp comprises a detachable shielding member, and after the shielding member is detached, the trigger end is exposed to the exposed portion.

3. The lamp according to claim 2, wherein
the shielding member is a light-transmitting member, a light-reflecting member or a light-shielding member.

4. The lamp according to claim 3, wherein
the shielding member comprises a reflector cup, the reflector cup is installed in the installation space and is blocked between the switch device and the opening, and after the reflector cup is detached, the trigger end is exposed to the exposed portion; or
the shielding member comprises a lamp shade, the lamp shade is installed at the opening and shields the switch device, and after the lamp shade is detached, the trigger end is exposed to the exposed portion; or
the shielding member comprises a surface cover, the surface cover is detachably installed at the opening and shields the switch device, and after the surface cover is detached, the trigger end is exposed to the exposed portion.

5. The lamp according to claim 3, wherein
the lamp comprises a first lamp shade, a second lamp shade and a surface cover, wherein the first lamp shade, the second lamp shade and the surface cover are all installed at the opening, the second lamp shade is located on an outer peripheral side of the first lamp shade, the surface cover is located at a center of the first lamp shade, the surface cover shields the switch device, and after the surface cover is detached, the trigger end is exposed to the exposed portion.

6. The lamp according to claim 5, wherein
the surface cover is made of a light-transmitting material, so that light is able to pass through the surface cover to be emitted, and the surface cover forms a complete light-emitting surface together with the first lamp shade and the second lamp shade, thereby preventing a black shadow from being generated at the surface cover.

7. The lamp according to claim 5, wherein
an installation base is further provided at the center of the first lamp shade, and a first position and a second position are formed in an inner space of the installation base, the first position is located above the second position, the first position has an inlet, and the second position has an outlet; a main body of the switch device is accommodated in the first position, and the trigger end of the switch device passes through a retaining wall of the installation base and reaches the second position, and the surface cover is detachably installed at the outlet and shields the second position.

8. The lamp according to claim 7, wherein
both the installation base and the surface cover are made of a light-transmitting material.

9. The lamp according to claim 3, wherein the lamp further comprises a switch handle, and the switch handle is arranged in an extension direction of the trigger end,
an end of the switch handle protrudes out of the opening and is exposed outside an outer side of the shielding member; or
the switch device is connected to the shielding member by the switch handle, wherein the shielding member shields the switch handle.

10. The lamp according to claim 1, wherein
the switch device is provided in the installation space, and the trigger end of the switch device is provided towards the opening;
the lamp further comprises a linkage assembly movably arranged, wherein a part of the linkage assembly is located in the exposed portion, and the linkage assembly is in linkage cooperation with the trigger end.

11. The lamp according to claim 10, wherein
the trigger end is a press-type trigger end; and
the linkage assembly is able to move in a pressing direction of the press-type trigger end.

12. The lamp according to claim 10, wherein
the linkage assembly comprises a light-transmitting member, a light-reflecting member, a light-shielding member, or a decorative member.

13. The lamp according to claim 10, wherein
the switch device is located inside the installation space and is arranged in a middle thereof, the linkage assembly comprises a linkage member installed in the installation space and a lamp shade provided in the exposed portion, the lamp shade shields the opening; and after being subjected to an acting force, the lamp shade is able to force the linkage member to move to a position where the trigger end is touched.

14. The lamp according to claim 10, wherein
the linkage assembly comprises a linkage member installed in the installation space and a lamp shade arranged on the exposed portion;
the linkage member is movably arranged, and the linkage member is fixedly connected to or separably arranged with the lamp shade; and after being subjected to an acting force, the lamp shade is able to force the linkage member to move to a position where the trigger end is touched.

15. The lamp according to claim 14, wherein
the linkage member is a long-strip member, a switch handle, a cylinder member or a reflector cup.

16. The lamp according to claim 14, wherein
the lamp shade is an anti-dazzle shade with an elastic ear edge; the elastic ear edge is located inside the lamp body and abuts against an inner wall of the lamp body; and after being subjected to an acting force, the lamp shade is able to force the linkage member to move to a position where the trigger end is touched.

17. The lamp according to claim 16, wherein
a surface of the anti-dazzle shield is formed by sequentially connecting a plurality of annular anti-dazzle surfaces of different diameters along the extension direction of the switch handle, and the diameter of the annular anti-dazzle surfaces gradually increases in the direction close to the opening; and/or
the lamp shade has a protruding portion for abutting against the switch device, the linkage member is the protruding portion, and vertical displacement is generated by using a deformation amount of the elastic ear edge, and the switch device is triggered by the protruding portion.

18. The lamp according to claim 1, wherein
the lamp comprises a plurality of light sources, the plurality of light sources comprising at least two light sources;
a light-emitting region is formed in the installation space, and the plurality of light sources are arranged corresponding to the same light-emitting region; or
the lamp further comprises a partition member, wherein the partition member partitions the installation space into at least two light-emitting regions, and the plurality of light sources respectively correspond to the plurality of light-emitting regions.

19. The lamp according to claim 18, wherein
the partition member is in a surrounding shape, and the partition member partitions the installation space into an inner peripheral light-emitting region and an outer peripheral light-emitting region located on the outer periphery of the inner peripheral light-emitting region; and/or
the partition member comprises a light-transmitting member, a light-reflecting member or a light-shielding member.

20. The lamp according to claim 1, wherein
the lamp is a down lamp, the down lamp comprises a connection structure matching a lamp tube, the connection structure comprises a connection base and a spring frame which are located on the lamp body;
the spring frame is rotatably connected to the connection base, or the spring frame is detachably connected to the connection base;
the spring frame is bent to form an insertion tongue, an insertion port is provided on the connection base, and the insertion tongue is detachably inserted into the insertion port.
